(19) United States
(12) Patent Application Publication
(10) Pub. No.: US 2009/0220170 A1
(43) Pub. Date: Sep. 3, 2009

(54) THREE-DIMENSIONAL IMAGE SPREADING APPARATUS

(75) Inventors: Chia-Lun Liu, Hsin-Tien City (TW); Chun-Chuan Liu, Hsin-Tien City (TW)

Correspondence Address: Muncy, Geissler, Olds & Lowe, PLLC, P.O. BOX 1364, FAIRFAX, VA, 22038-1364, US

(73) Assignee: ZIPPY TECHNOLOGY CORP., Hsin-Tien City (TW)

(21) Appl. No.: 12/041,477

(22) Filed: Mar. 3, 2008

(51) Int. Cl. G06K 9/36

(52) U.S. Cl. 382/276

(57) ABSTRACT

A three-dimensional image spreading apparatus to transform a three-dimensional image of an object to a planar image includes an incident element and an emitting element. The incident element has a first reflective portion formed with a closed circumferential surface, an image inlet and an image outlet that incorporate with the first reflective portion to form an image transmission passage. The first reflective portion has a perimeter shrinking gradually from the image inlet to the image outlet. The image inlet is extended outwards to form an image capturing zone to get images of the object to generate a corresponding circumferential image. The image emitting element is located in the image transmission passage and has a second reflective portion corresponding to the first reflective portion to receive the circumferential image and reflect the planar image through the image outlet to an image capturing device.

### BACKGROUND OF THE INVENTION

1. Field of the Invention

The present invention relates to a three-dimensional image spreading apparatus and particularly to an apparatus to unfold the three-dimensional image of an object to become a planar image with three-dimensional characteristics to fully present the object.

2. Brief Discussion of the Related Art

With continuous advances of technology image processing technique also has great progress and is widely used in living thing identification (ID for short hereinafter) technique. The living thing ID technique aims to make reliable and effective authenticity process of individual person through a computer based on unique physiological characteristics of the person. The present commonly used physiological characteristics includes face, iris, fingerprint and palm print. Face is the most natural and widely used personal ID characteristic in human vision. Hence facial ID is superior to other living thing ID techniques (such as fingerprint ID, iris ID and the like). ID purpose can be achieved without deliberated contact or actions of an ID target. It is less offensive to the targeted ID object. And users can operate the facial ID system covertly or more discreetly. Hence the facial ID system provides significant advantages in the application of security surveillance.

The conventional facial ID system usually captures the front image of a user's face through a video camera and maps against facial data in a system database to perform ID process. The image captured by the video camera could be easily blurred and become not recognizable due to external environmental factors such as light, makeup and the like. Some ill-intentioned persons can even exploit this shortcoming and tamper the facial ID system by wearing a facial mask or placing a photo at a desired location in front of the video camera to fool the ID system and produce an erroneous judgment thereof. This creates a big loophole in the security surveillance system. To remedy this problem, a facial ID system capable of simultaneously capturing the facial images of other visual angles has been developed. For instance, R.O.C. patent publication No. 200709075 entitled “Method and apparatus for detecting and recognizing human faces in set environments” discloses a technique which has a plurality of video cameras positioned at different angles to capture the front, left side and right side facial images of a targeted person. The facial images are analyzed to get required facial characteristics and a resulting image is obtained and sent to a facial ID module which retrieves a mapping facial image for comparison. Finally an ID result for legitimate and illegitimate person is generated.

While the patent set forth above can capture the images of a human face at different angles, and facial characteristics can be- obtained to perform ID process to improve the drawbacks of the conventional technique which takes only the front image, it require a number of video cameras, as a result the cost is higher. Moreover, due to environmental constraints installation locations of the video cameras are not always desirable and to fully capturing the facial images could be difficult. Even if all the issues previously discussed are overcome, the images taken at the multiple visual angles become a planar projection in the end. Projection blind spots are easily formed, such as some portions of the facial characteristics could be masked. Hence the resulting image still cannot fully reveal the three-dimensional characteristics. The result leaves a lot to be desired. There are still rooms for improvement.

### SUMMARY OF THE INVENTION

The primary object of the present invention is to solve the aforesaid disadvantages by providing a three-dimensional spreading apparatus to unfold a three-dimensional image to become a complete planar image which has three-dimensional characteristics regardless of environmental constraints.

To achieve the foregoing object the three-dimensional image spreading apparatus according to the invention includes an incident element and an emitting element. The incident element has a first reflective portion with a closed circumferential surface, an image inlet, an image outlet and an image transmission passage formed with the first reflective portion. The first reflective portion has a perimeter which gradually shrinks from the image inlet to the image outlet. There is an image capturing zone formed by extending the image inlet outwards. The image emitting element is located in the image transmission passage and has a second reflective portion corresponding to the first reflective portion. The three-dimensional image of an object located in the image capturing zone enters the image transmission passage through the image inlet and forms a circumferential image on the first reflective portion. The circumferential image is reflected to the second reflective portion and reflected thereon to become a planar image to be sent to an image capturing device through the image outlet. The planar image thus formed has comprehensive characteristics of the object, therefore can improve the disadvantages of incomplete image information caused by projection blind spots of the conventional planar image obtained by projection.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIGS. 1A and 1B are schematic views of a first embodiment of the invention.

FIG. 2 is an operation flowchart of the invention.

FIG. 3 is a schematic view of a second embodiment of the invention.

FIG. 4 is a schematic view of a third embodiment of the invention.

FIG. 5 is a schematic view of a fourth embodiment of the invention.

FIG. 6 is a schematic view of the invention with a local image enlarged.

### DETAILED DESCRIPTION OF THE PREFERRED EMBODIMENTS

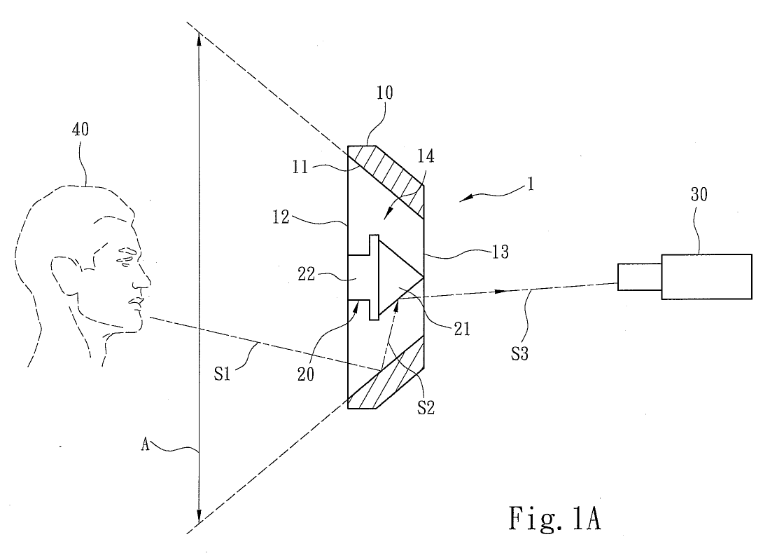

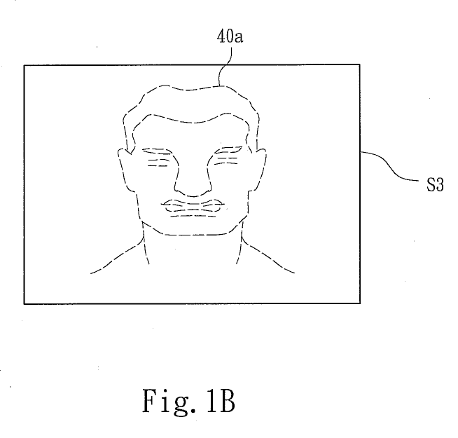

Please refer to FIGS. 1A and 1B, the three-dimensional image spreading apparatus 1, according to the invention mainly aims to transform a three-dimensional image S1 of an object 40 to a planar image S3. It includes an incident element 10 and an emitting element 20. The incident element 10 has a first reflective portion 11 with a closed circumferential surface, and an image inlet 12 and an image outlet 13 at two ends corresponding to each other. There is an image capturing zone A formed by extending the image inlet 12 outwards. The image inlet 12, the image outlet 13 and the first reflective portion 11 jointly form an image transmission passage 14. The emitting element 20 includes a seat 22 to hold a second reflective portion 21 corresponding to the first reflective portion 11. The first reflective portion 11 and the second reflective portion 21 are annular reflective mirrors with perimeters shrinking gradually from the image inlet 12 to the image outlet 13 to become a conical reflection structure. The second reflective portion 21 is parallel with the first reflective portion 11.

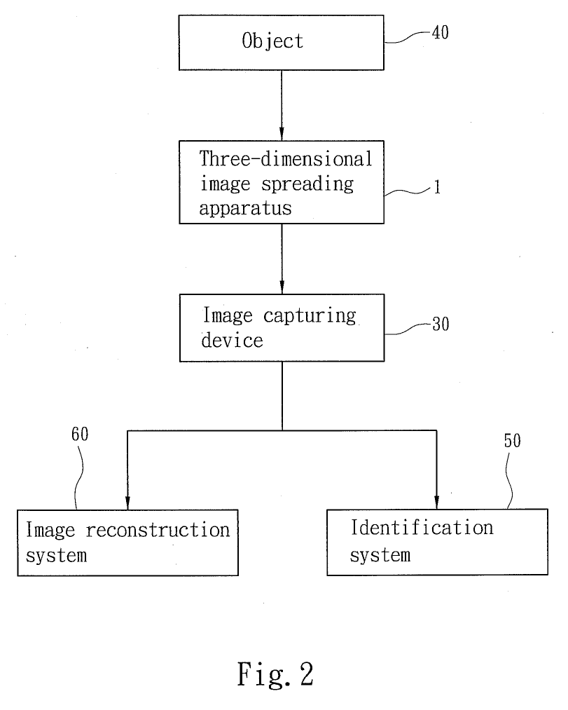

The three-dimensional image spreading apparatus 1 further has an image capturing device 30 corresponding to the image outlet 13. The image capturing device 30 may be a dynamic image recording device (such as a video camera) or a static image recording device (such as a camera or the like). More specifically, the three-dimensional image spreading apparatus 1 is substantially the lens of the image capturing device 30. When the object 40 (such as a targeted person shown in the drawings) enters the image capturing zone A, the three-dimension image S1 of the face of the targeted person enters the image transmission passage 14 through the image inlet 12 and projects onto the first reflective portion 11 to generate a circumferential image S2 which is reflected by the first reflective portion 11 to the second reflective portion 21, and further is reflected thereon and unfolded to become the planar image S3 (shown by a planar object 40a with three-dimensional characteristics indicated in FIG. 1B). The planar image S3 is reflected by the second reflective portion 21 to the image capturing device 30 through the image outlet 13. Referring to FIG. 2, the image capturing device 30 may be linked to an ID system 50, especially a facial ID system, to identify the planar image S3 and recognize whether the targeted person in the image capturing zone A is a legitimate person to prevent an ill-intentioned person to move close to the image capturing device 30 by means of another planar facial image (such as a photo) or a facial mask to create an erroneous judgment of the ID system 50. Moreover, the image capturing device 30 may further be linked to an image reconstruction system 60 to restore the image of the planar image S3, so that a security personnel database of the ID system 50 can be set up, or a simulated three-dimensional model of the targeted object 40 can be built to be incorporated with other ID methods, such as mapping the three-dimensional model against face phrenological features to perform facial ID.

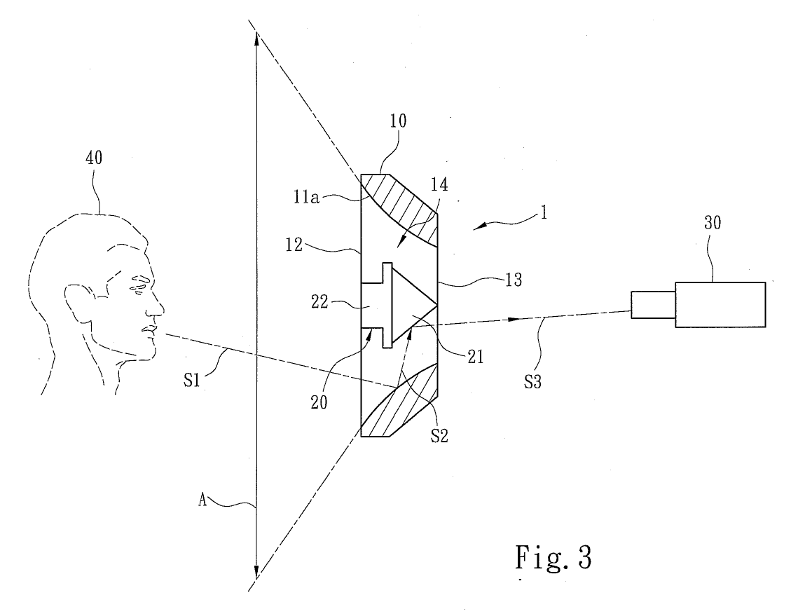

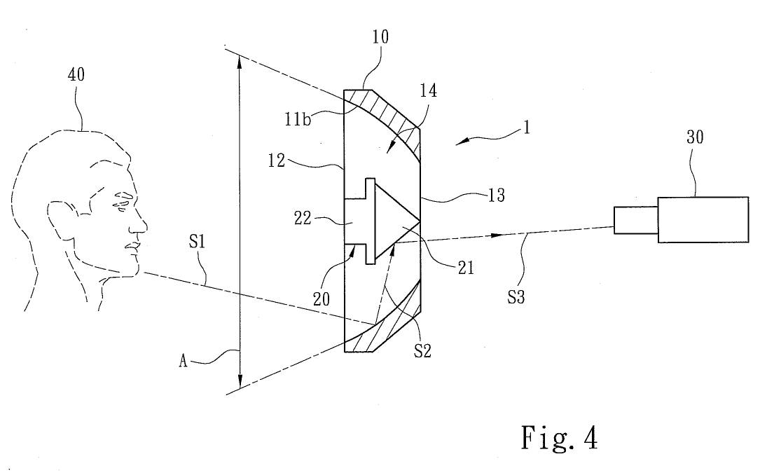

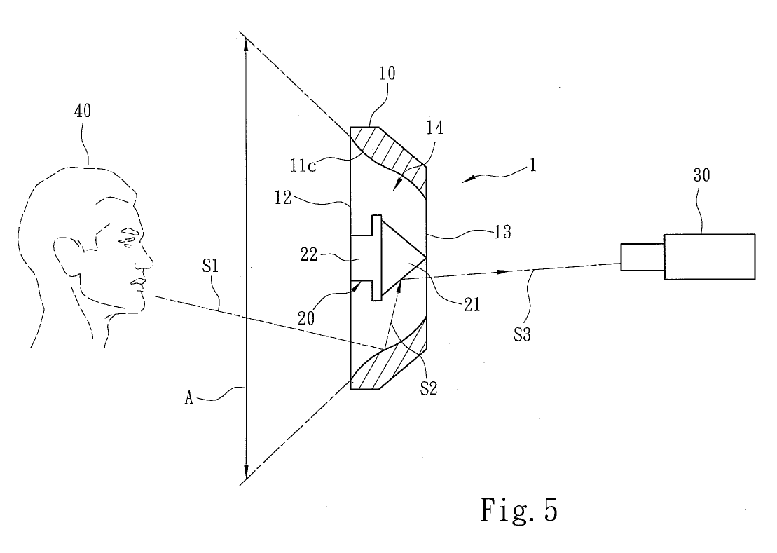

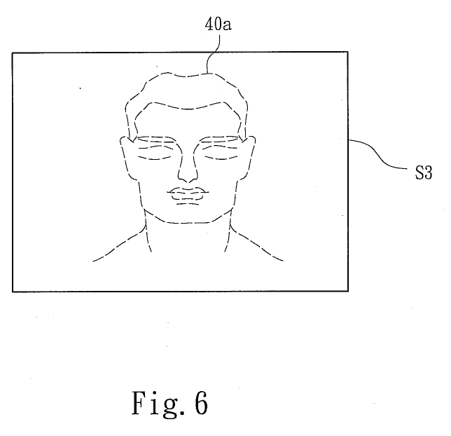

The first reflective portion 11 of the invention, aside from formed by the circumferential reflective mirror, may also be formed in other embodiments such as a convex mirror, a concave mirror, or a curved mirror consisting of convex and concave mirrors as shown in FIGS. 3, 4 and 5 by various types of first reflective portion 11a, 11b and 11c. Through the characteristics of light or image dispersion and converging of the convex and concave mirrors, the three-dimensional image S1 of the object 40 can be shrunk or enlarged to highlight local characteristics of the object 40. For instance, in FIG. 6, the eye characteristics of the targeted person are enlarged. The lens of the image capturing device 30 may also be replace to alter the types of the first reflective portions 11, 11a, 11b and 11c to thwart ill-intentioned persons from knowing the image transformation method of the three-dimensional image spreading apparatus 1 of the invention and trying to tamper the ID system through a selected facial model or mask. Thus ID effect and accuracy of the ID system 50 can be enhanced to further improve the guarding effect of the security surveillance system. It is to be noted that the types of the first reflective portion 11, 11a, 11b and 11c shown in the drawings and embodiments previously discussed are not the limitation of the invention. Users can make desired alterations or adjustments according to the local characteristics to be obtained.

As a conclusion, the present invention adopts the reflective principle of optics. By means of the first and second reflective portions 11 and 21, the three-dimension image S1 of the object 40 in the image capturing zone A can be reflected twice and unfolded to become the planar image S3 containing three-dimensional characteristics. Compared with the conventional techniques that get merely planar images of various visual angles through projecting images, the number of the image capturing device 30 can be reduced, and installation cost and time also are less. More important, the invention can overcome the image blind spots caused by the conventional image projection approach to fully present the image of the object 40.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A three-dimensional image spreading apparatus to transform a three-dimensional image of an object to become a planar image, comprising:
an incident element which has a first reflective portion formed with a closed circumferential surface, an image inlet and an image outlet that incorporate with the first reflective portion to form an image transmission passage, the first reflective portion having a perimeter shrinking gradually from the image inlet to the image outlet, the image inlet being extended outwards to form an image capturing zone to get three-dimensional images of varying visual angles of the object to generate a corresponding circumferential image; and
an emitting element which is located in the image transmission passage and has a second reflective portion corresponding to the first reflective portion to receive the circumferential image and reflect the planar image which is transmitted through the image outlet to an image capturing device.

2. The three-dimensional image spreading apparatus of claim 1, wherein the second reflective portion has a perimeter shrinking gradually from the image inlet to the image outlet.

3. The three-dimensional image spreading apparatus of claim 2, wherein the second reflective portion is parallel with the first reflective portion.

4. The three-dimensional image spreading apparatus of claim 1, wherein the second reflective portion is parallel with the first reflective portion.

5. The three-dimensional image spreading apparatus of claim 1, wherein the emitting element further has a seat located in the image transmission passage to hold the second reflective portion.

6. The three-dimensional image spreading apparatus of claim 1, wherein the first reflective portion is a convex mirror.

7. The three-dimensional image spreading apparatus of claim 1, wherein the first reflective portion is a concave mirror.

8. The three-dimensional image spreading apparatus of claim 1, wherein the first reflective portion includes a curved mirror consisting of a concave mirror and a convex mirror.

9. The three-dimensional image spreading apparatus of claim 1, wherein the image capturing device is a video camera.

10. The three-dimensional image spreading apparatus of claim 1, wherein the image capturing device is a camera.

11. The three-dimensional image spreading apparatus of claim 1, wherein the three-dimensional image spreading apparatus is a lens of the image capturing device.

12. The three-dimensional image spreading apparatus of claim 1, wherein the image capturing device is linked to an identification system to identify the planar image.

13. The three-dimensional image spreading apparatus of claim 1, wherein the image capturing device is linked to an image reconstruction system to restore the planar image.
